(19) United States
(12) Patent Application Publication
(10) Pub. No.: US 2006/0072010 A1
(43) Pub. Date: Apr. 6, 2006

(54) Target property maps for surveillance systems

(75) Inventors: Niels Haering, Reston, VA (US); Zeeshan Rasheed, Reston, VA (US); Andrew J. Chosak, Arlington, VA (US); Geoffrey Egnal, Washington, DC (US); Alan J. Lipton, Herndon, VA (US); Haiying Liu, Chantilly, VA (US); Peter L. Venetianer, McLean, VA (US); Weihong Yin, Herndon, VA (US); Li Yu, Herndon, VA (US); Liang Yin Yu, Herndon, VA (US); Zhong Zhang, Herndon, VA (US)

Correspondence Address: VENABLE LLP, P.O. BOX 34385, WASHINGTON, DC, 20045-9998, US

(73) Assignee: ObjectVideo, Inc., Reston, VA (US)

(21) Appl. No.: 10/948,785

(22) Filed: Sep. 24, 2004

(51) Int. Cl. H04N 7/18; H04N 9/47

(52) U.S. Cl. 348/143

(57) ABSTRACT

An input video sequence may be processed by processing the input video sequence to obtain target information; and building at least one target property map based on said target information. The target property map may be used to detect various events, particularly in connection with video surveillance.

### FIELD OF THE INVENTION

The present invention is related to video surveillance. More specifically, specific embodiments of the invention relate to a context-sensitive video-based surveillance system.

### BACKGROUND OF THE INVENTION

Many businesses and other facilities, such as banks, stores, airports, etc., make use of security systems. Among such systems are video-based systems, in which a sensing device, like a video camera, obtains and records images within its sensory field. For example, a video camera will provide a video record of whatever is within the field-of-view of its lens. Such video images may be monitored by a human operator and/or reviewed later by a human operator. Recent progress has allowed such video images to be monitored also by an automated system, improving detection rates and saving human labor.

In many situations it would be desirable to specify the detection of targets using relative modifiers such as fast, slow, tall, flat, wide, narrow, etc., without quantifying these adjectives. Likewise it would be desirable for state-of-the-art surveillance systems to adapt to the peculiarities of the scene, as current systems are unable to do so, even if the same systems have been monitoring the same scene for many years.

### SUMMARY OF THE INVENTION

Embodiments of the present invention are directed to enabling the automatic extraction and use of contextual information. Furthermore, embodiments of the present invention provides contextual information about moving targets. This contextual information may be used to enable context-sensitive event detection, and it may improve target detection, improve tracking and classification, and decrease the false alarm rate of video surveillance systems.

In particular, a video processing system according to an embodiment of the invention may comprise an up-stream video processing device to accept an input video sequence and output information on one or more targets in said input video sequence; and a target property map builder, coupled to said up-stream video processing device to receive at least a portion of said output information and to build at least one target property map.

In a further embodiment of the invention, a method of video processing may include processing an input video sequence to obtain target information; and building at least one target property map based on said target information.

Furthermore, the invention may be embodied in the form of hardware, software, firmware, or combinations thereof.

Definitions

The following definitions are applicable throughout this disclosure, including in the above.
A “video” refers to motion pictures represented in analog and/or digital form. Examples of video include: television, movies, image sequences from a video camera or other observer, and computer-generated image sequences.
A “frame” refers to a particular image or other discrete unit within a video.
An “object” refers to an item of interest in a video. Examples of an object include: a person, a vehicle, an animal, and a physical subject.
A “target” refers to a computer's model of an object. A target may be derived via image processing, and there is a one-to-one correspondence between targets and objects.
A “target instance,” or “instance,” refers to a sighting of an object in a frame.
An “activity” refers to one or more actions and/or one or more composites of actions of one or more objects. Examples of an activity include: entering; exiting; stopping; moving; raising; lowering; growing; and shrinking.
A “location” refers to a space where an activity may occur. A location may be, for example, scene-based or image-based. Examples of a scene-based location include: a public space; a store; a retail space; an office; a warehouse; a hotel room; a hotel lobby; a lobby of a building; a casino; a bus station; a train station; an airport; a port; a bus; a train; an airplane; and a ship. Examples of an image-based location include: a video image; a line in a video image; an area in a video image; a rectangular section of a video image; and a polygonal section of a video image.
An “event” refers to one or more objects engaged in an activity. The event may be referenced with respect to a location and/or a time.
A “computer” refers to any apparatus that is capable of accepting a structured input, processing the structured input according to prescribed rules, and producing results of the processing as output. Examples of a computer include: a computer; a general purpose computer; a supercomputer; a mainframe; a super mini-computer; a mini-computer; a workstation; a micro-computer; a server; an interactive television; a hybrid combination of a computer and an interactive television; and application-specific hardware to emulate a computer and/or software. A computer may have a single processor or multiple processors, which may operate in parallel and/or not in parallel. A computer also refers to two or more computers connected together via a network for transmitting or receiving information between the computers. An example of such a computer includes a distributed computer system for processing information via computers linked by a network.
A “computer-readable medium” refers to any storage device used for storing data accessible by a computer. Examples of a computer-readable medium include: a magnetic hard disk; a floppy disk; an optical disk, such as a CD-ROM and a DVD; a magnetic tape; a memory chip; and a carrier wave used to carry computer-readable electronic data, such as those used in transmitting and receiving e-mail or in accessing a network.
“Software” refers to prescribed rules to operate a computer. Examples of software include: software; code segments; instructions; computer programs; and programmed logic.
A “computer system” refers to a system having a computer, where the computer comprises a computer-readable medium embodying software to operate the computer.
A “network” refers to a number of computers and associated devices that are connected by communication facilities. A network involves permanent connections such as cables or temporary connections such as those made through telephone or other communication links. Examples of a network include: an internet, such as the Internet; an intranet; a local area network (LAN); a wide area network (WAN); and a combination of networks, such as an internet and an intranet.
A “sensing device” refers to any apparatus for obtaining visual information. Examples include: color and monochrome cameras, video cameras, closed-circuit television (CCTV) cameras, charge-coupled device (CCD) sensors, analog and digital cameras, PC cameras, web cameras, and infra-red imaging devices. If not more specifically described, a “camera” refers to any sensing device.
A “blob” refers generally to any object in an image (usually, in the context of video). Examples of blobs include moving objects (e.g., people and vehicles) and stationary objects (e.g., bags, furniture and consumer goods on shelves in a store).
A “target property map” is a mapping of target properties or functions of target properties to image locations. Target property maps are built by recording and modeling a target property or function of one or more target properties at each image location. For instance, a width model at image location (x,y) may be obtained by recording the widths of all targets that pass through the pixel at location (x,y). A model may be used to represent this record and to provide statistical information, which may include the average width of targets at location (x,y), the standard deviation from the average at this location, etc. Collections of such models, one for each image location, are called a target property map.

### BRIEF DESCRIPTION OF THE DRAWINGS

Specific embodiments of the invention will now be described in further detail in conjunction with the attached drawings, in which:

FIG. 1 depicts a flowchart of a content analysis system that may include embodiments of the invention;

FIG. 2 depicts a flowchart describing the training of target property maps according to an embodiment of the invention;

FIG. 3 depicts a flowchart describing the use of target property maps according to an embodiment of the invention; and

FIG. 4 depicts a block diagram of a system that may be used in implementing some embodiments of the invention.

### DETAILED DESCRIPTION OF VARIOUS EMBODIMENTS OF THE INVENTION

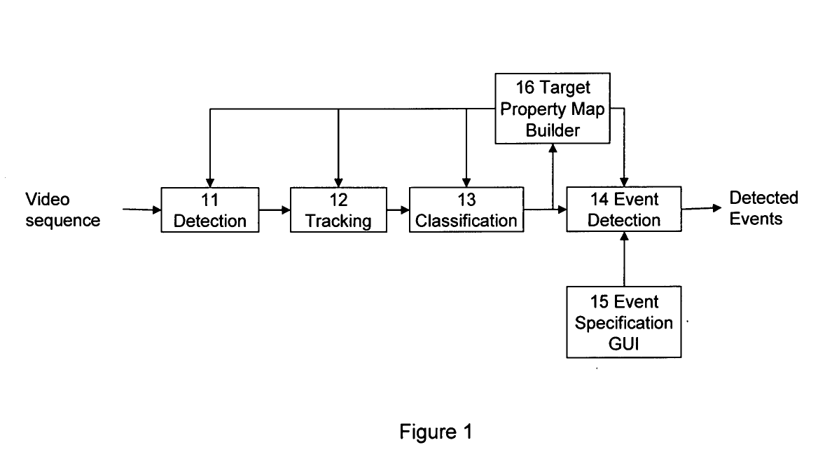

This invention may comprise part of a general surveillance system. A potential embodiment is illustrated in FIG. 1. Target property information is extracted from the video sequence by detection (11), tracking (12) and classification (13) modules. These modules may utilize known or as yet to be discovered techniques. The resulting information is passed to an event detection module (14) that matches observed target properties against properties deemed threatening by a user (15). For example, the user may be able to specify such threatening properties by using a graphical user interface (GUI) (15) or other input/output (I/O) interface with the system. The target property map builder (16) monitors and models the data extracted by the up-stream components (11), (12), and (13), and it may further provide information to those components. Data models may be based on a single target property or on functions of one or more target properties. Data models may be as simple as an average property value or a normal distribution model. Complex models may be produced based on algorithms tailored for a given set of target properties. For instance, a model may measure the ratio: (square root of a target's size) / (the target's distance to the camera).

Training Target Property Maps

The models that comprise target property maps may be built based on observation before they can be used; in an alternative embodiment, the target property models may be predetermined and provided to the system. The ensuing discussion will deal with the case in which the models are built as part of the process, but the other procedures are equally relevant to this alternative embodiment. For instance, the contextual information may be saved periodically to a permanent storage device, so that, following a system failure, much of the contextual information can be re-loaded from that permanent storage device. This embodiment provides the initial model information from an external—previously saved—source.

In embodiments of the invention where the models are built, to signal the validity of a model, it is labeled “mature” only after a statistically meaningful amount of data has been observed. Queries to the models that have not yet matured are not answered. This strategy leaves the system in its default mode until the models have matured. When the models have matured they may provide information that can be incorporated into the decision making processes of the connected algorithmic components, as shown in FIG. 1. The availability of this new evidence helps the algorithmic components to make better decisions.

Not all targets or their instances are necessarily used for training. The upstream components (11), (12), and (13) that gather target properties may fail, and it is important that the models are shielded from data that is faulty. One technique for dealing with this problem is to devise algorithms that carefully analyze the quality of the target properties. In other embodiments of the invention, a simple algorithm may be used that rejects targets and target instances if there is a doubt about their quality. This latter approach likely extends the time until target property maps achieve maturity. However, the prolonged time that many video surveillance systems spend viewing a scene makes this option attractive.

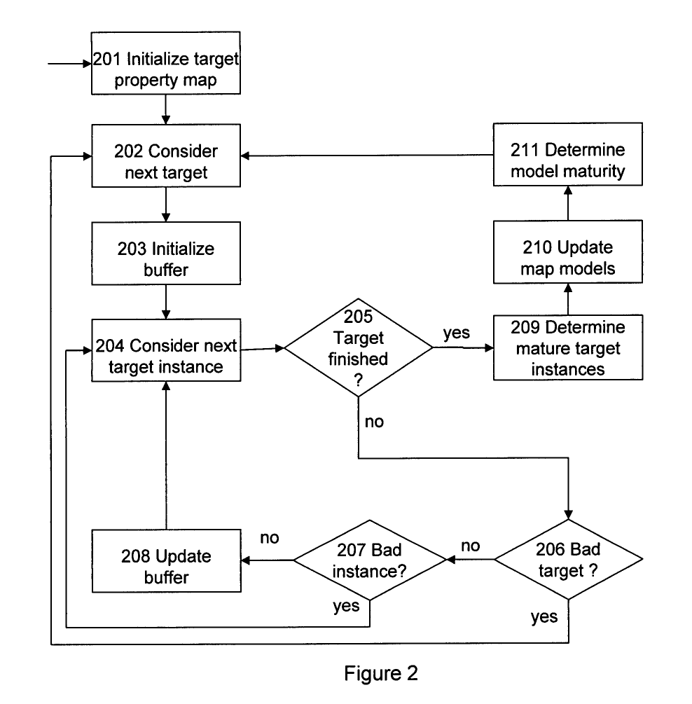

FIG. 2 depicts a flowchart of an algorithm for building target property maps, according to an embodiment of the invention. Such an algorithm may be implemented, for example, in Target Property Map Builder (16), as shown in FIG. 1. The algorithm may begin by appropriately initializing an array corresponding to the size of the target property map (in general, this may correspond to the image size) in Block 201. In Block 202, a next target may be considered. This portion of the process may begin with initialization of a buffer, which may be a ring buffer, of filtered target instances, in Block 203. The procedure may then proceed to Block 204, where a next instance (which may be stored in the buffer) of the target under consideration may be addressed. In Block 205, it is determined whether the target is finished; this is the case if all of its instances have been considered. If the target is finished, the process may proceed to Block 210 (to be discussed below). Otherwise, the process may then proceed to Block 206, to determine if target is bad; this is the case if this latest instance reveals a severe failure of the target's handling, labeling or identification by the up-stream processes. If this is the case, the process may loop back to Block 202, to consider the next target. Otherwise, the process may proceed with Block 207, to determine if the particular instance under consideration is a bad instance; this is the case if the latest instance reveals a limited inconsistency in the target's handling, labeling or identification by the up-stream process. If a bad instance was found, that instance is ignored and the process proceeds to Block 204, to consider the next target instance. Otherwise, the process may proceed with Block 208 and may update the buffer of filtered target instances, before returning to Block 204, to consider the next target instance.

Following Block 205 (as discussed above), the algorithm may proceed with Block 209, where it is determined which, if any, target instances may be considered to be “mature.” According to an embodiment of the invention, if the buffer is found to be full, the oldest target instance in the buffer may be marked “mature.” If all instances of the target have been considered (i.e., if the target is finished), then all target instances in the buffer may be marked “mature.”

The process may then proceed to Block 210, where target property map models may be updated at the map locations corresponding to the mature target instances. Following this map updating, the process may determine, in Block 211, whether or not each model is mature. In particular, if the number of target instances for a given location is larger than a preset number of instances required for maturity, the map location may be marked “mature.” As discussed above, only mature locations may be used in addressing inquiries.

Three potential exemplary implementations of embodiments of the invention according to FIG. 2 may differ in the implementations of the algorithmic components labeled 201, 206, 207, and 208.

A first implementation may be useful in providing target property maps for directly available target properties, such as, but not limited to, width, height, size, direction of motion, and target entry/exit regions. This may be accomplished by modifying only Block 208, buffer updating, to handle the different instances of this implementation.

A second implementation may be useful in providing target property maps for functions of multiple target properties, such as speed (change in location/change in time), inertia (change in location/target size), aspect ratio (target width/target height), compactness (target perimeter/target area), and acceleration (rate of change in location/change in time). In this case, Blocks 201 (map initialization) and 208 may be modified to handle the different instances of this embodiment.

The third implementation may be useful in providing target property maps that model current target properties in the context of each target's own history. These maps can help to improve up-stream components, and may include, but are not limited to, detection failure maps, tracker failure maps, and classification-failure maps. Such an implementation may require changes to modules 201, 206 (target instance filtering), 207 (target filtering) and 208, to handle the different instances of this implementation.

Using Target Property Maps

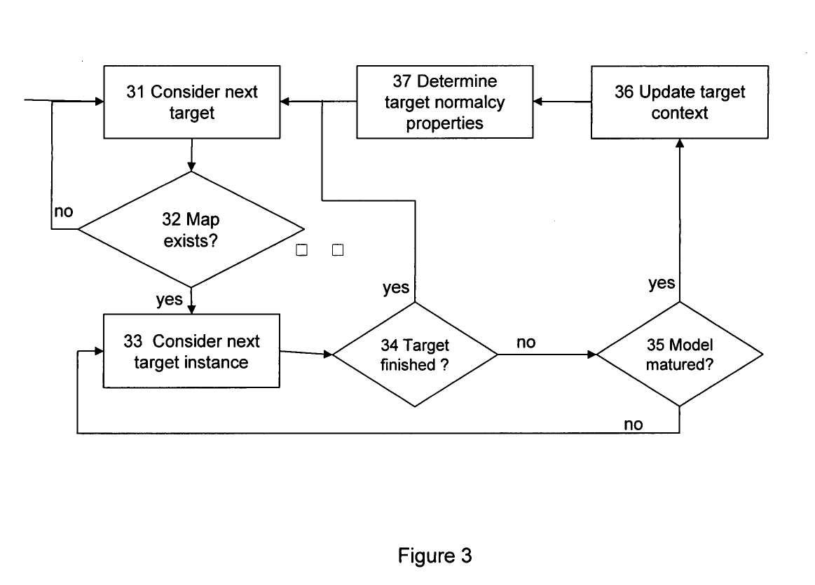

The algorithm described above, in connection with FIG. 2, may be used to build and maintain target property maps. However, to make them useful to a surveillance system they should also be able to provide information to the system. FIG. 3 depicts a flowchart of an algorithm for querying target property maps to obtain contextual information, according to an embodiment of the invention.

The algorithm of FIG. 3 may begin by considering a next target, in Block 31. It may then proceed to Block 32, to determine if the requested target property map has been defined. If not, the information about the target is unavailable, and the process may loop back to Block 31, to consider a next target.

If the requested target property map is determined to be available, the process may then consider a next target instance, in Block 33. If the instance indicates that the target is finished, in Block 34, the process may loop back to Block 31 to consider a next target; this is the case if all of the current target's instances have been considered. If the target is not finished, the process may proceed to Block 35 and may determine if the target property map model at the location of the target instance under consideration has matured. If it has not matured, the process may loop back to Block 33 to consider a next target instance. Otherwise, the process may proceed to Block 36, where the target context may be updated. The context of a target is updated by recording the degree of its conformance with the target property map maintained by this algorithm. Following Block 36, the process may proceed to Block 37 to determine normalcy properties of the target based on its target property context. The context of each target is maintained to determine whether it acted in a manner that is inconsistent with the behavior or observations predicted by the target property map model. Finally, following Block 37, the procedure may return to Block 31 to consider a next target.

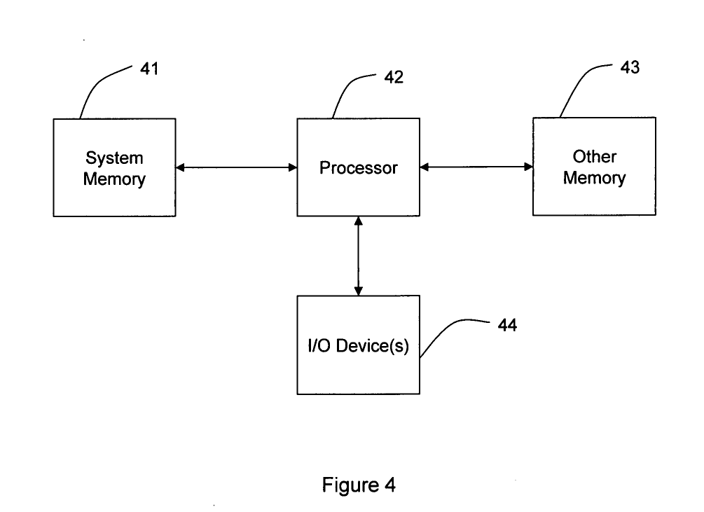

Some embodiments of the invention, as discussed above, may be embodied in the form of software instructions on a machine-readable medium. Such an embodiment is illustrated in FIG. 4. The computer system of FIG. 4 may include at least one processor 42, with associated system memory 41, which may store, for example, operating system software and the like. The system may further include additional memory 43, which may, for example, include software instructions to perform various applications. The system may also include one or more input/output (I/O) devices 44, for example (but not limited to), keyboard, mouse, trackball, printer, display, network connection, etc. The present invention may be embodied as software instructions that may be stored in system memory 41 or in additional memory 43. Such software instructions may also be stored in removable or remote media (for example, but not limited to, compact disks, floppy disks, etc.), which may be read through an I/O device 44 (for example, but not limited to, a floppy disk drive). Furthermore, the software instructions may also be transmitted to the computer system via an I/O device 44 for example, a network connection; in such a case, a signal containing the software instructions may be considered to be a machine-readable medium.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A video processing system comprising:
an up-stream video processing device to accept an input video sequence and output information on one or more targets in said input video sequence; and
a target property map builder, coupled to said up-stream video processing device to receive at least a portion of said output information and to build at least one target property map.

2. The system according to claim 1, wherein said up-stream video processing device comprises:
a detection device to receive said input video sequence;
a tracking device coupled to an output of said detection device; and
a classification device coupled to an output of said tracking device, an output of said classification device being coupled to an input of said target property map builder.

3. The system according to claim 1, further comprising:
an event detection device coupled to receive an output of said target property map builder and to output one or more detected events.

4. The system according to claim 3, further comprising:
an event specification interface coupled to said event detection device to provide one or more events of interest to said event detection device.

5. The system according to claim 4, wherein said event specification interface comprises a graphical user interface.

6. The system according to claim 1, wherein said target property map builder provides feedback to said up-stream video processing device.

7. The system according to claim 1, wherein said target property map builder comprises:
at least one buffer.

8. A method of video processing, comprising:
processing an input video sequence to obtain target information; and
building at least one target property map based on said target information.

9. The method according to claim 8, wherein said processing an input video sequence comprises:
detecting at least one target;
tracking at least one target; and
classifying at least one target.

10. The method according to claim 8, wherein said building at least one target property map comprises:
for a given target, considering at least one instance of the target;
filtering said at least one instance of the target; and
determining if said at least one instance of the target is mature.

11. The method according to claim 10, wherein said building at least one target property map further comprises:
if at least one instance of the target is mature, updating at least one map model corresponding to at least one location where an instance of the target is mature.

12. The method according to claim 11, wherein said building at least one target property map further comprises:
determining if at least one model forming part of said at least one target property map is mature.

13. The method according to claim 8, further comprising:
detecting at least one event based on said at least one target property map.

14. The method according to claim 13, wherein said detecting at least one event comprises:
for a given target, comparing at least one property of the target with at least one property of said at least one target property map.

15. The method according to claim 14, wherein said comparing comprises:
using a user-defined comparison criterion.

16. The method according to claim 13, further comprising:
obtaining at least one user-defined criterion for event detection.

17. A computer-readable medium containing instructions that, when executed by a processor, cause the processor to perform the method according to claim 8.

18. A video processing system comprising:
a computer system; and
the computer-readable medium according to claim 17.

19. A video surveillance system comprising:
at least one camera to generate an input video sequence; and
the video processing system according to claim 18.
